(19) United States
(12) Patent Application Publication
(10) Pub. No.: US 2023/0362865 A1
(43) Pub. Date: Nov. 9, 2023

(54) METHOD AND DEVICE FOR OBTAINING NETWORK DATA SERVER INFORMATION IN WIRELESS COMMUNICATION SYSTEM

(71) Applicant: Samsung Electronics Co., Ltd., Suwon-si (KR)

(72) Inventor: Jungshin PARK, Suwon-si (KR)

(21) Appl. No.: 18/309,429

(22) Filed: Apr. 28, 2023

(30) Foreign Application Priority Data
May 4, 2022 (KR) 10-2022-0055545

(51) Int. Cl. H04W 60/04

(52) U.S. Cl. CPC H04W 60/04

(57) ABSTRACT

The disclosure relates to a 5G or 6G communication system for supporting a higher data transmission rate. In a wireless communication system, a UE may transmit identification information about the UE to an application registration server for service registration for an application, obtain information about a network data server related to the application through a registration procedure for accessing a mobile communication network, and receive data to be used for the application from the network data server based on the obtained information.

### CROSS-REFERENCE TO RELATED APPLICATION

This application is based on and claims priority under 35 U.S.C. § 119 to Korean Patent Application No. 10-2022-0055545, which was filed in the Korean Intellectual Property Office on May 4, 2022, the entire disclosure of which is incorporated herein by reference.

### BACKGROUND

### 1. Field

Various embodiments of the present disclosure relate to a method and device for obtaining network data server information in a wireless communication system.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (Bandwidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Edge computing refers to performing computing at or close to the physical position of the user or data source. If the computing service is processed close to the user's UE, the user may receive faster and more reliable service.

With the development of mobile communication systems as described above, it has become easier for the UE to access the computing power provided by the server in the network on demand through the mobile communication system. As a result, use of AI applications that utilize machine learning (ML) algorithms, which require complex computations that were once thought to be impossible to perform on the UE, is increasingly being considered.

These AI applications may utilize the resources of network servers through wireless communication systems. Therefore, since the performance of the application experienced by the user is greatly affected by the communication state of the wireless communication system, a technology capable of controlling the ML model or algorithm in response to the state of the wireless communication system is required.

### SUMMARY

Various embodiments of the present disclosure provide a method and device for obtaining network data server information in a wireless communication system.

Various embodiments of the present disclosure provide a method and device for obtaining information about a network data server for receiving network data required by an application of a UE.

Various embodiments of the present disclosure provide a method and device for a UE to search for a network data server to request and receive network state information in a wireless communication system.

Various embodiments of the present disclosure provide a method and device for controlling the signal flow between a UE and network entities for providing network data server information to the UE.

According to an embodiment, a method for obtaining network data server information by a user equipment (UE) in a wireless communication system may comprise transmitting identification information about the UE to an application registration server for service registration for an application, obtaining information about a network data server related to the application through a registration procedure for accessing a mobile communication network, and receiving data to be used for the application from the network data server based on the obtained information.

According to an embodiment, a method for providing network data server information by a first network device in a wireless communication system may comprise obtaining application information corresponding to identification information about a UE, determining a network data server related to an application used by the UE based on the application information, and providing information about the determined network data server to a second network device to provide the information about the determined network data server to the UE.

According to an embodiment, a UE in a wireless communication system may comprise a transceiver and at least one processor configured to control the transceiver to transmit identification information about a UE to an application registration server for service registration for an application, obtain information about a network data server related to the application through a registration procedure for accessing a mobile communication network, and control the transceiver to receive data to be used for the application from the network data server based on the obtained information.

According to an embodiment, a first network device in a wireless communication system may comprise a transceiver and at least one processor configured to, obtain application information corresponding to identification information about a UE, determine a network data server related to an application used by the UE based on the application information, and control the transceiver to provide information about the determined network data server to a second network device to provide the information about the determined network data server to the UE.

Various embodiments of the disclosure may obtain information about a network data server for receiving network data required by an application of the UE (e.g., an application using AI and/or ML).

Various embodiments of the disclosure may provide the UE with information about a network data server corresponding to a movement pattern based on the position and/or time of the UE.

Various embodiments of the disclosure may provide information about a network data server suitable for a UE state to the UE based on various pieces of information related to an application (e.g., UE position, time, model information, and model-specific server information).

According to various embodiments of the disclosure, a UE may receive network state information and perform an operation corresponding to the network state in a wireless communication system. For example, if the current network conditions are expected to be congested, the UE may determine to apply a simplified learning or inference model to reduce the amount of data transfer and throughput required for learning and inference and, if the current network conditions are smooth, the UE may determine to use a complex model to improve performance.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 illustrates a configuration of a wireless communication network according to various embodiments of the present disclosure;

FIG. 2 illustrates a process of receiving network data server information from a wireless communication system by a UE according to various embodiments of the present disclosure;

FIGS. 3A and 3B illustrate flowcharts for obtaining network data server information by a UE according to various embodiments of the present disclosure; and

FIG. 4 illustrates an electronic device according to various embodiments of the present disclosure.

### DETAILED DESCRIPTION

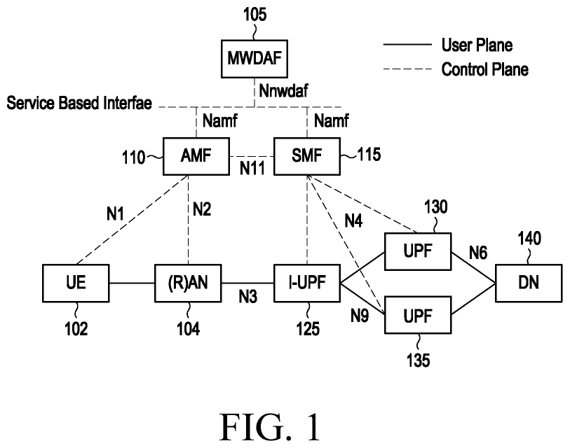

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure are described in detail with reference to the accompanying drawings. When determined to make the subject matter of the disclosure unclear, the detailed description of the related functions or configurations in the embodiments of the disclosure may be skipped. The terms as used herein are defined considering the functions in the disclosure and may be replaced with other terms according to the intention or practice of the user or operator. Therefore, the terms should be defined based on the overall disclosure.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit or part” means a software element or a hardware element such as a field-programmable gate array (FPGA) or an application specific integrated circuit (ASIC). A “unit” or “part” may be configured to play a certain role. However, a “unit” is not limited to software or hardware. A “unit” may be configured in a storage medium that may be addressed or may be configured to execute one or more processors. Accordingly, as an example, a “unit” includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the “units” may be combined into smaller numbers of components and “units” or further separated into additional components and “units.” Further, the components and “units” may be implemented to execute one or more CPUs in a device or secure multimedia card. According to embodiments, a “ . . . unit” may include one or more processors and/or devices.

For ease of description, some of the terms or names defined in the 3rd generation partnership project long term evolution (3GPP)-based communication standards (e.g., 5G, NR, LTE, or similar system standards) may be used. However, the disclosure is not limited by such terms and names and may be likewise applicable to systems conforming to other standards.

As used herein, terms for identifying access nodes, terms denoting network entities, terms denoting messages, terms denoting inter-network entity interfaces, and terms denoting various pieces of identification information are provided as an example for ease of description. Thus, the disclosure is not limited to the terms, and the terms may be replaced with other terms denoting objects with equivalent technical meanings.

In various embodiments of the disclosure, the terminal may be various types of electronic devices, such as a user equipment (UE), a mobile station (MS), a cellular phone, and a smartphone. Hereinafter, an example in which the terminal is a UE is described below.

The description of embodiments of the disclosure focuses primarily on the radio access network, new RAN (NR), and the core network, packet core (5G system, or 5G core network, or NG core, or next generation core), which are specified by the 3rd generation partnership (3GPP) which is a mobile communication standardization organization. However, the subject matter of the disclosure, or slight changes thereto, may also be applicable to other communication systems that share similar technical backgrounds without departing from the scope of the disclosure, which would readily be appreciated by one of ordinary skill in the art.

In the 5G mobile communication system, a network data collection and analysis function (NWDAF), which is a network function (NF) for network automation support, may be used. The NWDAF may collect, store, and analyze information from the 5G network and provide the results of the analysis to at least one NF. The results analyzed by the NWDAF may be used independently in each NF.

In a 5G mobile communication system, the NFs may use the results of collection and analysis of network-related data (hereinafter referred to as network data) through the NWDAF. This is to use the collection and analysis results of network data necessary for each NF to effectively provide its own functions in a centralized form. The NWDAF may collect and analyze network data using a network slice as a basic unit. However, the scope of the disclosure is not limited to the network slice unit, and the NWDAF may additionally analyze various pieces of information (e.g., service quality) including at least one of user equipment (UE), packet data unit (PDU) session, NF state, and/or quality of service obtained from an external service server.

The results analyzed through the NWDAF may be delivered to each NF that requests the analysis results, and the delivered analysis results may be used to optimize network management functions, such as ensuring and/or enhancing quality of service (QoS), traffic control, mobility management, and load balancing.

The unit nodes that perform their respective functions provided by the 5G mobile communication system may be defined as NFs (also referred to as “NF entities,” “NF objects,” or “NF nodes”). Each NF may include at least one of, e.g., an access and mobility management function (AMF) that manages access and mobility of the UE to an access network (AN), a session management function (SMF) that performs session-related management, a user plane function (UPF) that manages the user data plane, and a network slice selection function (NSSF) that selects network slice instances available to the UE.

FIG. 1 illustrates a configuration of a wireless communication network according to various embodiments of the present disclosure.

Referring to FIG. 1, an NWDAF 105 may collect network data from at least one source NF, e.g., an NF in the 5G core network, such as at least one of an AMF 110, SMF 115, I-UPF 125, UPF 130, and UPF 135, an application function (AF) for efficiently providing a service, a network exposure function (NEF), or an operation, administration, and maintenance (OAM) in various manners. The AMF 110 may access the UE 100 and a radio access network (RAN) 120, and each of the I-UPF 125, the UPF 130, and the UPF 135 may connect user traffic of the UE 100 through the RAN 120 to at least one data network (DN) 140.

Further, the NWDAF 105 may provide at least one consumer NF with analysis results of network data collected in the network or externally. The NWDAF 105 may collect and analyze the load level information about the network slice instance and provide it to the NSSF to be used for selection to be used by a specific UE. The service-based interface defined in the 5G network may be used to request or transfer analysis information including analysis results between the NFs (e.g., AMF 110 and SMF 115) and the NWDAF 105, and a hypertext transfer protocol (HTTP) and/or JavaScript object notation (JSON) document-based method may be used as the transfer method.

The data collected by the NWDAF 105 may include at least one of, e.g., the application identifier (ID) from the point coordination function (PCF), IP filter information, media/application bandwidth, the UE identifier (UE ID) from the AMF 110, location information, destination data network name (DNN) from the SMF 115, UE IP, QoS flow bit rate, QoS flow ID (QFI), QoS flow error rate, QoS flow delay, or traffic usage report from the UPF 125, 130, or 135.

The NWDAF 105 may additionally collect and use for analysis, at least one of, e.g., the NF resource status from the OAM, which is an entity capable of influencing connection between the UE and the service server, other than the NFs constituting the core network, NF throughput, service level agreement (SLA) information, UE status from the UE 100, UE application information, UE usage pattern, the service application identifier received from the AF, service experience, or traffic pattern.

Tables 1 to 3 below show examples of network data collected by the NWDAF 105. The period and time when the NWDAF 105 collects network data from each entity may differ from entity to entity. Further, the correlation between the collected data may be identified through the timestamp for recording the time of collection and the correlation ID for correlating the data of each collection target.

TABLE 1

| Information | Source | Description |
|---|---|---|
| Application ID | AF | To identify the service and |
| | | support analytics per type of |
| | | service (the desired level of |
| | | service) |
| IP filter information | AF | Identify a service flow of the |
| | | UE for the application |
| Locations of Application | AF/NEF | Locations of application |
| | | represented by a list of |
| | | DNAI(s). The NEF may map |
| | | the AF-Service-Identifier |
| | | information to a list of |
| | | DNAI(s) when the DNAI(s) |
| | | being used by the application |
| | | are statically defined. |
| Service Experience | AF | Refers to the quality of |
| | | experience (QoE) per service |
| | | flow as established in the |
| | | SLA and during on boarding. |
| | | It can be either e.g., MOS or |
| | | video MOS as specified in |
| | | ITU-T P.1203.3 or a |
| | | customized MOS |
| Timestamp | AF | A time stamp associated to |
| | | the Service Experience |
| | | provided by the AF, |
| | | mandatory if the Service |
| | | Experience is provided by the |
| | | ASP. |

TABLE 2

| Information | Source | Description |
|---|---|---|
| Timestamp | 5GC NF | A time stamp associated with the collected |
| | | information. |
| Location | AMF | The UE location information. |
| SUPI(s) | AMF | If UE IDs are not provided as target of analytics |
| | | reporting for slice service experience, AMF returns the |
| | | UE IDs matching the AMF event filters. |
| DNN | SMF | DNN for the PDU Session which contains the QoS |
| | | flow |
| S-NSSAI | SMF | S-NSSAI for the PDU Session which contains the QoS |
| | | flow |
| Application ID | SMF | Used by NWDAF to identify the application service |
| | | provider and application for the QoS flow |
| IP filter | SMF | Provided by the SMF, which is used by NWDAF to |
| information | | identify the service data flow for policy control and/or |
| | | differentiated charging for the QoS flow |
| QFI | SMF | QoS Flow Identifier |
| QoS flow Bit Rate | UPF | The observed bit rate for UL direction; and The |
| | | observed bit rate for DL direction |
| QoS flow Packet | UPF | The observed Packet delay for UL direction; and The |
| Delay | | observed Packet delay for the DL direction |
| Packet | UPF | The observed number of packet transmission |
| transmission | | |
| Packet | UPF | The observed number of packet retransmission |
| retransmission | | |

TABLE 3

| Information | Source | Description |
|---|---|---|
| Timestamp | OAM | A time stamp associated with the collected |
| | | information. |
| Reference Signal Received | OAM | The per UE measurement of the received power level |
| Power | | in a network cell, including SS-RSRP, CSI-RSRP as |
| | | specified in TS 38.331 and E-UTRA RSRP as |
| | | specified in TS 36.331 |
| Reference Signal Received | OAM | The per UE measurement of the received quality in a |
| Quality | | network cell, including SS-RSRQ, CSI-RSRQ as |
| | | specified in TS 38.331 and E-UTRA RSRQ as |
| | | specified in TS 36.331 |
| Signal-to-noise and | OAM | The per UE measurement of the received signal to |
| interference ratio | | noise and interference ratio in a network cell, |
| | | including SS-SINR, CSI-SINR, E-UTRA RS-SINR, |
| | | as specified in TS 38.215 |

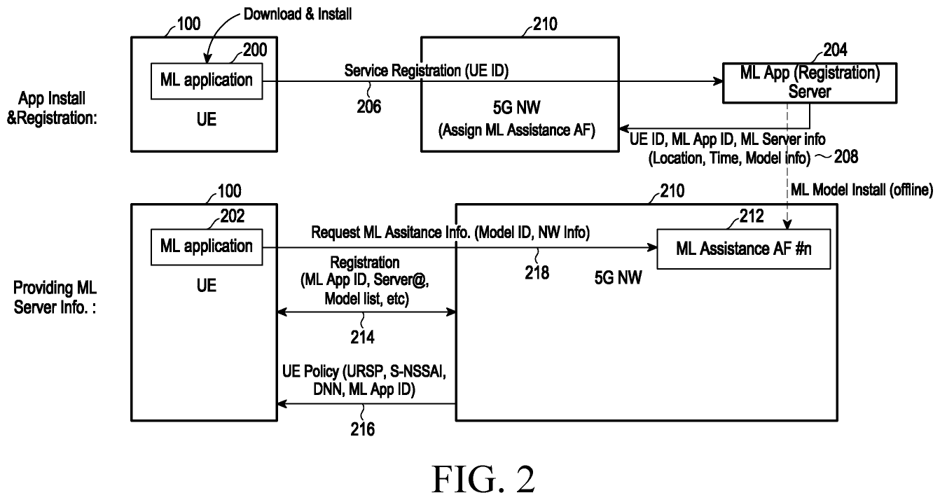

FIG. 2 illustrates a process of receiving network data server information from a wireless communication system by a UE according to various embodiments of the present disclosure.

Referring to FIG. 2, an application 202 may be installed on the UE 100. The application 202 may be installed on the UE 100 based on user selection or input, and may be an application that utilizes AI and/or ML (hereinafter referred to as an “AI/ML application”).

In the process of installing the AI/ML application 202 on the UE 100, the AI/ML application 202 may perform a consent and registration process for service initiation with the AI/ML application (registration) server 204 designated by the application provider for the user's consent to transmitting and receiving UE 100 information and user information to and from the network data server. In the service registration process, the AI/ML application 202 may transfer the identifier information, i.e., UE IE, about the UE 100 designated in the mobile communication system, to the AI/ML application (registration) server 204 (206).

According to an embodiment, the UE ID is external identifier information about the UE 100 used in the mobile communication system, and may be, e.g., a phone number or other specific numbers assigned to the UE 100. Further, the AI/ML application provider may operate a separate registration server for the purpose of processing only the service registration process.

Upon receiving a service registration request from the UE 100, the AI/ML application (registration) server 204 may transmit AI/ML application information to the mobile communication network (e.g., 5G network (network, NW) or mobile operator network) 210 that the UE 100 is using based on the UE ID received from the UE 100 (208). The AI/ML application information may include AI/ML application ID and AI/ML server information (such as location, time, model-specific server information, and model information).

The mobile communication network 210 may receive AI/ML application information from the AI/ML application (registration) server 204 and assign a network data server (AI/ML assistance AF) 210 corresponding to the received AI/ML application information (such as location, time, model-specific server information, and model information). The mobile communication network 210 may store information about the assigned network data server (AI/ML assistance AF) 212 as subscription information about the UE 100.

In the process of connecting to the wireless communication system, the UE 100 may perform a registration process with the mobile communication network 210 and receive network data server information (such as an AI/ML assistance AF address) to be used for the AI/ML application 202 through the registration process 214. In an embodiment, the UE 100 may initiate a registration process to transmit the application ID for the AI/ML application 202 to the mobile communication network 210 and receive network data server information corresponding to the application ID from the mobile communication network 210. Alternatively, the UE 100 may initiate a registration process to transmit an indicator indicating that reception of network data associated with the AI/ML application 202 is needed to the mobile communication network 210 and receive network data server information based on the indicator from the mobile communication network 210. The network data server information may be received from the mobile communication network 210, for example, via a registration acceptance message or a control message such as a UCU.

Separate from the registration procedure, the UE 100 may also receive network data server information from the mobile communication network 210 by performing a UE configuration update procedure with the mobile communication network 210 or a separately specified procedure. In this process, the UE 100 may receive UE route selection policy (URSP) information 216 as information about the session policy to be used for communication with the network data server 212. The URSP may include single-network slice selection assistance information (S-NSSAI) and/or DNN information as network slice identification information designated for communication with the network data server for each AI/ML application by the UE 100. The URSP may be provided from the mobile communication network 210 based on the application ID or indicator.

Subsequently, when the AI/ML application 202 requests network state information from the communication module of the UE 100, the UE 100 may request and receive the network state information required by the AI/ML application 202 from the designated network data server 212 using the network data server information received through the above-described registration process 214 or a separate designated procedure.

When the AI/ML application provider has configured the network data server 212 to transmit AI/ML model data for use by the UE 100 based on, e.g., an agreement with the mobile operator, the AI/ML application (registration) server 204 may store the AI/ML model data in the network data server 212 in advance. Further, the AI/ML application 202 may request and receive the AI/ML model data, as part of the network data, via the communication module of the UE 100.

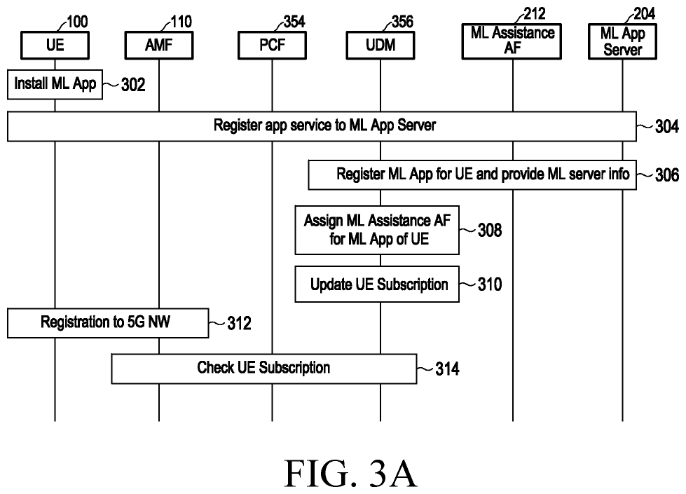

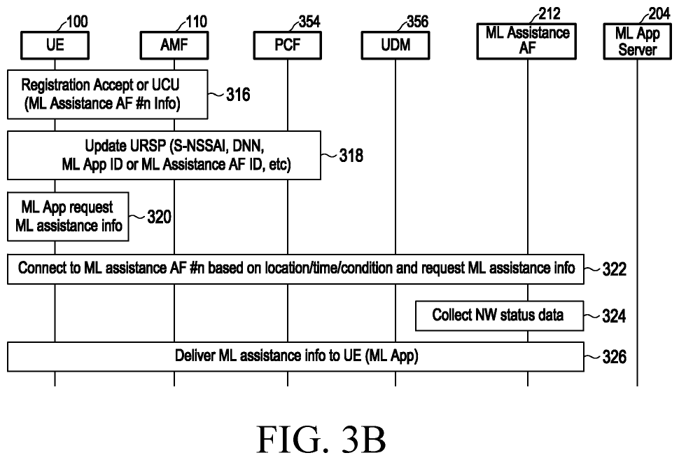

FIGS. 3A and 3B illustrate flowcharts for obtaining network data server information by a UE according to various embodiments of the present disclosure.

Referring to FIG. 3A, in step 302, the UE 100 may install an AI/ML application (e.g., the AI/ML application 202 of FIG. 2). According to an embodiment, the AI/ML application may be installed based on the user selection or input. In step 304, the UE 100 may perform a consent and registration process for service initiation with the AI/ML, application (registration) server 204 to process the user's consent to use the service and consent to provide UE information in the service registration process for use of the AI/ML, application. During the service registration process, the UE 100 may transfer UE ID information to the AI/ML application (registration) server 204 via the AI/ML application. According to an embodiment, the UE ID information may be external identifier information (e.g., a phone number or other specific numbers assigned to the UE 100) of the UE 100 designated in the mobile communication system.

In step 306, the AI/ML application (registration) server 204 may connect to the mobile communication network being used by the UE 100 based on the UE ID received from the UE 300. The AI/ML application (registration) server 204 may register AI/ML application information with the UDM 356 of the mobile communication system by requesting the mobile communication network so that the AI/ML application may request network data. The AI/ML application information may include the AI/ML application ID and AI/ML application server information (such as location, time, model-specific server information, and model information).

In step 308, the UDM 356 of the mobile communication system may receive AI/ML application information from the AI/ML application (registration) server 204 and assign a network data server (AI/ML assistance AF) corresponding to the AI/ML application information (such as location, time, model-specific server information, and model information). According to an embodiment, the UDM 356 may assign different network data servers depending on the address (location) of the AI/ML application server that the AI/ML application accesses at a particular time and location, or may assign different network data servers depending on the size of the model used by the AI/ML application.

When a network data server is assigned, the UDM 356 may update the UE 100's subscription information by storing information about the assigned network data server as the UE 100's subscription information.

In step 312, the UE 100 may perform a registration procedure in the process of accessing the wireless communication system (e.g., 5G NW). The UE 100 may include information about each AI/ML application to be used by the UE 100 during the registration process (e.g., the ID of each AI/ML application or an indicator indicating that it is needed to receive network data associated with each AI/ML application) in the registration request message and transmit it to the network.

In step 314, the AMF 110 may request the UE 100's subscription information from the UDM 356 based on the UE 100's registration request message. According to an embodiment, the AMF 110 may request the UE 100's subscription information by transmitting the application ID or indicator included in the registration request message to the UDM 356, and receive subscription information corresponding to the application ID or indicator from the UDM 356.

Based on the received subscription information, the AMF 110 may identify the information about the AI/ML applications allowed to the UE 100 and the information about the network data server to be accessed by the UE 100 at the current location for each AI/ML application. Based on the identified information, the AMF 110 may determine, e.g., whether to allow the UE 100 to access the network data server.

In step 316 of FIG. 3B, which follows step 314 of FIG. 3A, the AMF 110 may transmit to the UE 100, via a registration acceptance message, information about the network data server (such as an AI/ML assistance AF address) to be accessed for each AI/ML application according to the current location and time. According to an embodiment, the UE 100 may receive the network data server information from the network through a network and UE configuration update procedure or a separately designated procedure separate from the registration procedure.

The UE 100 may perform the process of requesting and receiving network status information required by the AI/ML application from the designated network data server using the network data server information received through the registration procedure or a separate designated procedure. When the AI/ML application provider has configured the network data server 212 to transmit AI/ML model data for use by the UE 100 based on, e.g., an agreement with the mobile operator, the AI/ML application (registration) server 204 may store the AI/ML model data in the network data server 212 in advance. The AI/ML application may request and receive the AI/ML model data, as part of the network data, via the communication module of the UE 100.

In step 318, the UE 100 may receive UE route selection policy (URSP) information that includes information about the session policy to be applied by the UE 100 to communications with the network data server for each AI/ML application. The URSP information may include information such as the S-NSSAI and DNN that is designated to be used by the UE 100 for communication with the network data server for each AI/ML application. Whenever the location of the UE 100 changes, the UE 100 may receive updated network data server information to be used for each AI/ML application at the changed current location from the network, either through the above-described registration process or a separate process, as needed.

In step 320, the AI/ML application of the UE 100 may request network data from the communication module of the UE 100 (or system software of the UE 100) that is needed to determine, e.g., a learning or inference model of the AI/ML application.

In step 322, the communication module of the UE 100 (or the system software of the UE 100) may access the network data server designated for the AI/ML application based on the information received from the network in the previously performed steps, and request the network data requested by the AI/ML application (AI/ML assistance info).

In step 324, the network data server 212 may perform the operation of collecting network state data from each NF and the NWDAF 105 to provide the network data requested by the UE 100.

In step 326, the network data server 212 may generate the network data (AI/ML assistance Info) requested by the UE 100 based on the collected data, and transmit the generated network data to the UE 100. The communication module (or system software) of the UE 100 may transfer the network data received to the AI/ML application via, e.g., an internal interface or API. The AI/ML application may use the received network data to identify the current network state and determine a learning model and/or inference model (model size or type) appropriate for the identified network state. For example, if the current network conditions are expected to be congested, the AI/ML application may determine to apply a simplified learning or inference model to reduce the amount of data transfer and throughput required for learning and inference and, if the current network conditions are smooth, the UE may determine to use a complex model to improve performance.

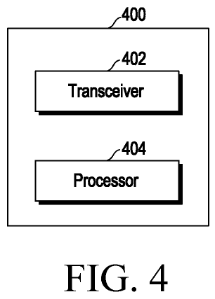

FIG. 4 illustrates an electronic device according to various embodiments of the present disclosure.

According to various embodiments, an electronic device 400 shown in FIG. 4 may be any one of the devices shown in FIGS. 1 to 3B (e.g., UE 100, AMF 110, AI/ML application (registration) server 204, network data server 212, PCF 354, and UDM 356).

Referring to FIG. 4, the electronic device 400 may include a transceiver 402 and a processor 404.

The transceiver 402 may transmit/receive signals or messages to/from at least one other device.

The processor 404 may control the transceiver 402 and perform operations based on at least one of various embodiments as described above. The processor 404 may include an application processor and a communication processor.

The transceiver 402 and the processor 404 are not necessarily implemented as separate modules but rather as a single component, e.g., a single chip. The transceiver 402 and the processor 404 may be electrically connected with each other. In an embodiment, the processor 404 may indicate a circuit, an application-specific circuit, or at least one processor. The operations of the electronic device 400 may be realized by including a memory device storing a corresponding program code in the electronic device 400 (e.g., the processor 404 and/or another component not shown). The embodiments herein are provided merely for better understanding of the disclosure, and the disclosure should not be limited thereto or thereby. In other words, it is apparent to one of ordinary skill in the art that various changes may be made thereto without departing from the scope of the disclosure. Further, the embodiments may be practiced in combination. For example, the respective, at least portions, of the embodiments of the disclosure may be combined and operated by the base station or the UE.

In the above-described specific embodiments, the components included in the disclosure are represented in singular or plural forms depending on specific embodiments provided. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

The embodiments herein are provided merely for better understanding of the disclosure, and the disclosure should not be limited thereto or thereby. The above-described embodiments of the disclosure are merely an example, and it will be appreciated by one skilled in the art that various changes and other equivalents thereof may be made. Accordingly, the scope of the disclosure should be determined by the technical spirit of the disclosure as claimed in the claims.

Although the present disclosure has been described with various embodiments, various changes and modifications may be suggested to one skilled in the art. It is intended that the present disclosure encompass such changes and modifications as fall within the scope of the appended claims.

What is claimed:

1. A method of a user equipment (UE) for obtaining network data server information in a wireless communication system, the method comprising:
transmitting, to an application registration server, identification information associated with the UE for a service registration for an application;
obtaining, through a registration procedure, information associated with a network data server related to the application for accessing a mobile communication network; and
receiving, from the network data server, data for the application based on the obtained information.

2. The method of claim 1, wherein the network data server information includes address information associated with the network data server.

3. The method of claim 1, wherein application information corresponding to the identification information associated with the UE is stored in the application registration server, wherein the network data server is determined based on the application information, and
wherein the application information includes identification information associated with the application, model information for at least one of learning and inference of the application, and application server information based on at least one of the model information, time, or a location of the UE.

4. The method of claim 1, further comprising receiving, from the mobile communication network, information associated with a session policy for a communication with the network data server,
wherein the information associated with the session policy includes at least one of domain network name information or network slice identification information for the communication with the network data server.

5. The method of claim 1, wherein obtaining, through the registration procedure, the network data server information includes obtaining information associated with the network data server related to the application based on one of the identification information associated with the application and an indicator indicating that a reception of data for the application is needed.

6. A method of a first network device for providing network data server information in a wireless communication system, the method comprising:
obtaining application information corresponding to identification information associated with a user equipment (UE);
determining, based on the application information, a network data server related to an application used by the UE; and
transmitting, to a second network device, information associated with the determined network data server to provide the information associated with the determined network data server to the UE.

7. The method of claim 6, wherein the information associated with the determined network data server is provided, through a registration procedure, to the UE for accessing a mobile communication network by the UE, and
wherein the information is used for receiving, from the network data server, data for the application.

8. The method of claim 6, wherein the network data server information includes address information associated with the network data server.

9. The method of claim 6, wherein the application information includes identification information associated with the application, model information for at least one of learning and inference of the application, and application server information based on at least one of the model information, time, or a location of the UE.

10. The method of claim 6, wherein information associated with a session policy for a communication with the network data server is provided to the UE, and wherein information associated with the session policy includes at least one of domain network name information or network slice identification information for the communication with the network data server.

11. A user equipment (UE) in a wireless communication system, comprising:
a transceiver; and
at least one processor operably coupled to the transceiver, the at least one processor configured to:
control the transceiver to transmit, to an application registration server, identification information associated with the UE for a service registration for an application;
obtain, through a registration procedure, information associated with a network data server related to the application for accessing a mobile communication network; and
control the transceiver to receive, from the network data server, data for the application based on the obtained information.

12. The UE of claim 11, wherein network data server information includes address information associated with the network data server.

13. The UE of claim 11, wherein application information corresponding to the identification information associated with the UE is stored in the application registration server, wherein the network data server is determined based on the application information, and
wherein the application information includes identification information associated with the application, model information for at least one of learning and inference of the application, and application server information based on at least one of the model information, time, or a location of the UE.

14. The UE of claim 11, wherein the at least one processor is configured to control the transceiver to receive, from the mobile communication network, information associated with a session policy for a communication with the network data server, and
wherein the information associated with the session policy includes at least one of network slice identification information or domain network name information for the communication with the network data server.

15. The UE of claim 11, wherein the at least one processor is configured to obtain, through the registration procedure, information associated with the network data server related to the application based on one of the identification information associated with the application and an indicator indicating that a reception of data for the application is needed.

16. A first network device in a wireless communication system, comprising:
a transceiver; and
at least one processor operably coupled to the transceiver, the at least one processor configured to:
obtain application information corresponding to identification information associated with a user equipment (UE);
determine, based on the application information, a network data server related to an application used by the UE; and
control the transceiver to transmit, to a second network device, information associated with the determined network data server to provide the information associated with the determined network data server to the UE.

17. The first network device of claim 16, wherein the information associated with the determined network data server is provided, through a registration procedure, to the UE for accessing a mobile communication network by the UE, and
wherein the information is used for receiving, from the network data server, data for the application.

18. The first network device of claim 16, wherein network data server information includes address information associated with the network data server.

19. The first network device of claim 16, wherein the application information includes identification information associated with the application, model information for at least one of learning and inference of the application, and application server information based on at least one of the model information, time, or a location of the UE.

20. The first network device of claim 16, wherein information associated with a session policy for a communication with the network data server is provided to the UE, and wherein information associated with the session policy includes at least one of domain network name information or network slice identification information for the communication with the network data server.
